(19) United States
(12) Patent Application Publication
(10) Pub. No.: US 2011/0207491 A1
(43) Pub. Date: Aug. 25, 2011

(54) Apparatus for and Method of Improving Multi-RAT Out-of-Service Performance

(76) Inventor: Arvind Swaminathan, San Diego, CA (US)

(21) Appl. No.: 13/029,447

(22) Filed: Feb. 17, 2011

Related U.S. Application Data
(60) Provisional application No. 61/306,157, filed on Feb. 19, 2010.

(51) Int. Cl. H04B 7/26

(52) U.S. Cl. 455/509

(57) ABSTRACT

Systems and methodologies are described that facilitate re-acquisition of service after an out-of-service (OOS) condition occurs. Mobile devices are equipped to retain information about the system in use just prior to the OOS condition occurring and use this information to determine the parameters of a service search. These parameters can include one or more of a determination of which radio access technologies (RATs) will be searched, the amount of time allocated to search for each RAT, and the order in which each RAT may be searched.

### CLAIM OF PRIORITY UNDER 35 U.S.C. §119

The present Application for Patent claims priority to Provisional Application No. 61/306,157 entitled “Improving Multi-RAT Out-of-Service Performance” filed Feb. 19, 2010, and assigned to the assignee hereof and hereby expressly incorporated by reference herein.

### BACKGROUND

The present disclosure relates generally to communication, and more specifically to techniques for searching for wireless communication systems.

Wireless communication systems are widely deployed to provide various communication services; for instance, voice, video, packet data, broadcast, and messaging services can be provided via such wireless communication systems. These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and Single-Carrier FDMA (SC-FDMA) systems.

Generally, wireless multiple-access communication systems may simultaneously support communication for multiple mobile devices. Each mobile device may communicate with one or more base stations via transmissions on forward and reverse links The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

As wireless communication technology advances, a growing number of different radio access technologies are being utilized. For instance, many geographic areas are now served by multiple wireless communication systems, each of which can utilize one or more different air interface technologies. In order to increase versatility of wireless terminals in such a network environment, there recently has been an increasing trend toward multi-mode wireless terminals that are able to operate under multiple radio access technologies. For example, a multi-mode implementation can enable a terminal to select a system from among multiple systems in a geographic area, each of which may utilize different radio interface technologies, and subsequently communicate with one or more chosen systems. Conventionally, system selection in a wireless communication environment is based on priority lists, which list the preferred order in which a terminal is to attempt access to systems in a geographic area.

Upon power up, the wireless device may search for a wireless system from which it may receive service. If a system is found, then the wireless device may register with the system. The wireless device may then actively communicate with the system or go into an idle mode if communication is not immediately required. If the wireless device subsequently loses the system, then it may enter an out-of-service (OOS) state and attempt to acquire a system from which service may be obtained.

The wireless device may not have any knowledge of its operating environment while in the OOS state and may not know which systems, if any, can be acquired. This may necessitate an exhaustive search for all possible radio access technologies, without regard to whether such radio access technologies may be unlikely to exist in a given location, or to how much time should be allocated to each radio access technology during a scan, or to in which order a scan should be conducted. Thus searches are potentially inefficient, which can lead to prolonged reacquisition times.

There is therefore a need in the art for techniques to efficiently search for wireless systems in the OOS state.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to one aspect, an apparatus for wireless communications is described. The apparatus includes at least one processor configured to cause the apparatus to transition to an out-of-service (OOS) state upon detection of an OOS condition for a first radio access technology, and to configure at least one parameter of a system search to reacquire a second radio access technology the same as or different from the first radio access technology based on at least one attribute of the first radio access technology. The processor is also configured to cause the apparatus to conduct the system search. The apparatus also includes a memory coupled to the processor.

In another aspect the processor is further configured to determine which radio access technologies are most likely to be found based in least in part on the first attribute.

The at least one attribute of the first radio access technology may be a type of air interface technology employed by the first radio access technology. The at least one attribute of the first radio access technology may also be a location associated with the first radio access technology.

The at least one parameter may be a scan list of systems to be sought during the system search. The processor may be further configured to determine the scan list by causing certain frequencies within a radio access technology to be eliminated in at least one scan. In another aspect, the processor may be further configured to determine the scan list by causing certain frequencies within a radio access technology to be repeated multiple times in at least one scan.

The processor may be configured to determine the scan list by causing selected radio access technologies not to be scanned for in at least one scan. The processor may cause the selected radio access technologies not to be scanned by eliminating the selected radio access technologies from the scan list.

In another aspect, the at least one parameter may be an amount of time a radio access technology is sought in at least one scan of the system search. The at least one parameter may alternatively or also be an order in which radio access technologies are sought during the system search.

In another aspect, the processor may be configured to be able to configure at least parameter of the system search based on by causing selected radio access technologies not to appear on a scan list of radio access technologies to be sought for at least one scan, by determining an amount of time during the at least one scan to seek radio access technologies on the scan list, and by determining an order in which to search for radio access technologies on the scan list.

In another aspect, a method is described. The method includes the steps of transitioning to an out-of-service (OOS) state upon detection of an OOS condition for a first radio access technology and defining a system search based on at least one parameter to reacquire a second radio access technology the same as or different from the first radio access technology, wherein the at least one parameter is based on at least one attribute of the first radio access technology and performing the system search. The at least one attribute of the first radio access technology may be a type of air access technology employed by the first radio access technology. In another aspect, the at least one attribute of the first radio access technology may be a location associated with the first radio access technology. The at least one parameter may be a scan list of systems to be sought during at least a portion of the system search. The scan list may be defined by causing selected radio access technologies not to appear on the scan list. The at least one parameter may also or alternatively be an amount of time a radio access technology is sought in at least one scan of the system search. The at least one parameter may also or alternatively be an order in which radio access technologies are sought in at least one scan of the system search. In another aspect the defining step comprises causing selected radio access technologies not to be sought during at least a portion of the system search, allocating an amount of time to scan for radio access technologies at least one scan of the system search, and determining a sequence in which to search for radio access technologies in at least one scan of the system search.

In another aspect, a described apparatus comprises means for transitioning to an out-of-service (OOS) state upon detection of OOS conditions for a first radio access technology and means for performing a system search based on at least one parameter to reacquire a second radio access technology the same as or different from the first radio access technology, wherein the at least one parameter is based on at least one attribute of the first radio access technology. The at least one attribute of the first radio access technology may be a type of air access technology employed by the first radio access technology. The at least one attribute of the first radio access technology may also or alternatively be a location associated with the first radio access technology. The at least one parameter may be a scan list of radio access technologies to be sought during the system search.

In another aspect, the search defining means may comprise means for selecting radio access technologies not to be sought during at least one scan of the system search. The search defining means may also or alternatively comprise scan time allocating means for allocating an amount of time a radio access technology is scanned for in during at least one scan of the system search. The search defining means may also or alternatively comprise sequence determining means for determining an order in which radio access technologies are sought during at least one scan of the system search.

In another aspect, the determining means may comprises means for causing selected radio access technologies not to be searched for during at least one scan of the system search, means for allocating an amount of time to scan for radio access technologies in at least one scan of the system search, and means for determining a sequence in which to search for radio access technologies in at least one scan of the system search.

According to another aspect, a computer program product is disclosed that comprises a computer-readable medium, the computer-readable medium comprising a first set of codes for causing a computer to transition to an out-of-service (OOS) state upon detection of OOS conditions for a first radio access technology and a second set of codes for causing a computer to determine at least one parameter of system search to reacquire a second radio access technology the same as or different from the first radio access technology based at least in part on at least one attribute of the first radio access technology.

In another aspect, an apparatus is described that includes an out-of-service module configured to detect an out-of-service condition for a first radio access technology and a reacquisition search module coupled to the out-of-service module and configured to perform a system search to reacquire a second radio access technology the same as or different from the first radio access technology in response to detection of an out-of-service condition by the out-of service module, the reacquisition search module including a search defining module configured to determine at least one parameter of the system search based on at least one attribute of the first radio access technology.

In yet another aspect, an apparatus is described that includes at least one processor configured to cause the apparatus to transition to an out-of-service (OOS) state upon detection of an OOS condition for a first radio access technology, configure at least one parameter of a system search to reacquire a second radio access technology the same as or different from the first radio access technology based on an apparent location of the apparatus, and cause the apparatus to conduct the system search. The apparatus also may include a memory coupled to the processor. The processor may be additionally configured to determine the apparent location of the apparatus from location information associated with the first radio access technology. The processor may alternatively be configured to determine the apparent location of the apparatus from location information associated with the first radio access technology and configure the at least one parameter of a system search to reacquire the second radio access technology based on the apparent location of the apparatus by limiting at least an initial scope of the search to radio access technologies in the apparent location.

To the accomplishment of the foregoing and related ends, one or more aspects of the claimed subject matter comprise the features hereinafter fully described and particularly pointed out in the claims. The following description and the annexed drawings set forth in detail certain illustrative aspects of the claimed subject matter. These aspects are indicative, however, of but a few of the various ways in which the principles of the claimed subject matter can be employed. Further, the disclosed aspects are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example methodology that facilitates reacquisition of signal after an out-of-service detection in a wireless device.

FIG. 3 is an illustration of further detail of an example step in the methodology shown in FIG. 2.

FIG. 4 is an illustration of further detail of an example of a step in the methodology shown in FIG. 3.

FIG. 5 is an example of a timing diagram for a set of scans in a system search that facilitates reacquisition of signal after an out-of-service detection in a wireless device.

FIG. 6 is a functional diagram of a wireless device capable of improved service reacquisition.

FIG. 7 is a functional diagram of a wireless device capable of improved service reacquisition.

### DETAILED DESCRIPTION

Various embodiments are now described with reference to the drawings, wherein like reference numerals are used to refer to like elements throughout. In the following description, for purposes of explanation, numerous specific details are set forth in-order to provide a thorough understanding of one or more embodiments. It may be evident, however, that such embodiment(s) can be practiced without these specific details. In other instances, well-known structures and devices are shown in block diagram form in-order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio access technology (“RAT”) such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). Additionally, the techniques described herein can be employed in broadcast networks, such as a MediaFLO network, that allow efficient broadcast transmission of data to a plurality of mobile devices over a forward link without requiring a reverse link for requesting such data.

The terms “radio access technology”, “RAT”, “radio technology”, and “air interface” are often used interchangeably. C2K or cdma2000 covers IS-2000, IS-95 and IS-856 standards. IS-2000 is also referred to as CDMA2000 IX, IX, etc. IS-856 is also referred to as HRPD, CDMA2000 1xEV-DO, 1xEVDO, DO, High Data Rate (HDR), etc. UTRA includes Wideband-CDMA (W-CDMA) and Time Division-Synchronous CDMA (TD-SCDMA). A TDMA system may implement a RAT such as GSM. An OFDMA system may implement a RAT such as Evolved UTRA (E-UTRA), IEEE 802.20, Flash-OFDM®, etc. UTRA and E-UTRA are part of UMTS, and Long Term Evolution (LTE) is an upcoming release of UMTS utilizing E-UTRA. UTRA, E-UTRA, UMTS, GSM and LTE are described in documents from an organization named “3rd Generation Partnership Project” (3GPP). cdma2000 is described in documents from an organization named “3rd Generation Partnership Project 2” (3GPP2). These various RATs and standards are known in the art.

GSM and IS-95 are second-generation (2G) RATs that can provide voice service and low to medium rate packet data service. UMTS, IS-2000, and IS-856 are third-generation (3G) RATs that can provide enhanced services and capabilities, e.g., higher data rates, concurrent voice and data calls, etc. A network operator/service provider may deploy one or more systems utilizing one or more RATs.

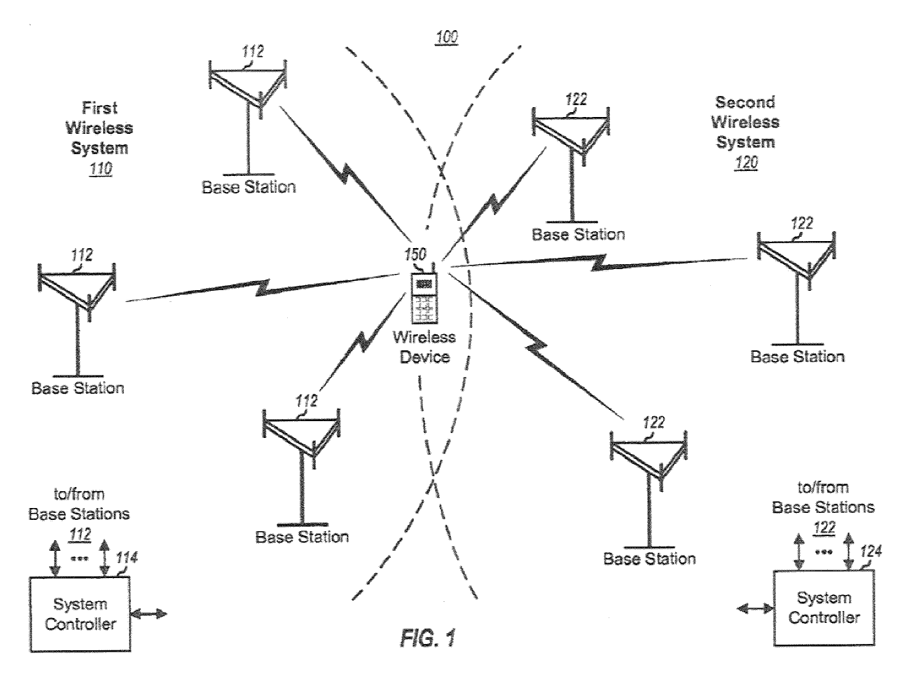

FIG. 1 shows a deployment 100 that includes a first wireless system 110 and a second wireless system 120. In one example, system 110 may be a GSM system, and system 120 may be a UMTS system. In another example, system 110 may also be a 1X system, and system 120 may be an HRPD system. It is noted, however, that systems 110 and 120 may also be systems utilizing other RATs.

System 110 includes base stations 112 that communicate with wireless devices within the coverage area of system 110. A base station is generally a fixed station that communicates with the wireless devices and may also be referred to as a Node B, an evolved Node B (eNode B), an access point, etc. A system controller 114 couples to base stations 112 and provides coordination and control for these base stations. System 120 includes base stations 122 that communicate with wireless devices within the coverage area of system 120. A system controller 124 couples to base stations 122 and provides coordination and control for these base stations. System controllers 114 and 124 may each comprise one or more network entities such as, but not limited to, a Mobile Switching Center (MSC), a Radio Network Controller (RNC), a Packet Control Function (PCF), etc. System controller 114 may communicate with system controller 124 to support inter-working between systems 110 and 120.

A system typically includes many cells, where the term “cell” can refer to a base station or the coverage area of the base station, depending on the context in which the term is used. In the following description, base stations 112 and 122 may be referred to as cells.

A wireless device 150 may be able to communicate with system 110 and/or system 120, typically with one system at any given moment. Wireless device 150 may be stationary or mobile and may also be referred to as a user equipment (UE), a mobile station (MS), a terminal, an access terminal, a mobile equipment, a subscriber unit, a station, etc. Wireless device 150 may be a cellular phone, a personal digital assistant (PDA), a wireless modem, a handheld device, a laptop computer, etc.

Wireless device 150 may search for systems upon power up. If a system is found, then the wireless device may operate in either (i) a connected mode and actively communicate with the system to obtain service or (ii) an idle mode and camp on the system if communication is not required. The wireless device may fail to acquire a system at power up (e.g., if it is in an area with no service) or may lose an acquired system while in the idle or connected mode (e.g., due to user mobility or radio link failure). The wireless device may then enter an OOS state and search for systems suitable for camping or obtaining service.

In general, the wireless device may enter the OOS state based on various criteria. In one design, the wireless device may enter the OOS state immediately upon failure to acquire a system during power up or upon loss of an acquired system in the idle or connected mode. In another design, the wireless device may wait some amount of time after system acquisition failure at power up or after system loss in the idle or connected mode and then enter the OOS state. For example, the wireless device may be in the idle mode and may periodically demodulate a paging channel during assigned paging slots, which may be spaced apart by a time interval. The wireless device may either (i) declare system loss after failure to demodulate the paging channel and immediately enter the OOS state or (ii) continue to attempt to demodulate the paging channel in each paging slot and declare system loss and enter the OOS state after a number of unsuccessful demodulation attempts. The wireless device may also continuously search for systems for a period of time prior to entering the OOS state.

One strategy for finding a new RAT when the UE goes OOS is for the UE to scan exhaustively for every possible RAT based on a priority order. According to the described apparatus and method, however, in one aspect the UE first eliminates RATs from the scan order, at least for a period of time. Here and elsewhere, “eliminate” with reference to a RAT is intended to refer to causing the RAT not to appear in the scan order, and is intended, for example, to encompass cases where the RAT is removed from a scan order as well as cases where the RAT is not placed in the scan order. Also, in another aspect, when the UE goes OOS, re-acquisition performance may be improved if, during an overall scan to find a new RAT, the UE scans for each candidate RAT for a certain amount of time. Hence, according to another aspect, the described apparatus and methods provide each RAT with a certain amount of in a time-division multiplexed fashion. Also, according to another aspect, the described apparatus and methods may determine a new scan order, e.g. a new ordering of or priority of searching for the RATs on a scan list.

In one aspect, when the UE discovers a first system, it uses this information to determine its current location. The UE then uses its current location to optimize subsequent scans. In an aspect, the UE uses rules to determine the RATs that are most likely to exist in the area the UE went out-of-service. In an aspect, the UE also may use rules to determine how much time in each scan should be allocated to a given RAT, or the sequence in which these RATs are scanned

After the UE loses service, an OOS module on the UE invokes a function to determine if any RATs can be eliminated from an original list of possible RAT's based on the UE's location. If certain RATs can be eliminated, the UE will not scan for systems on these RATs at least for a first T_restrict seconds. If the UE does not find any system in the first T_restrict seconds, the UE can modify its scan pattern, e.g. by reverting to scanning for all RATs on the original list.

A multimode UE is typically provisioned with several databases that can supply the original list of RATs. For example, for 3GPP2 MMSS operation the UE is provisioned with Multi-Mode System Selection (MSS) Location Priority List (MLPL) records that identify the 3GPP and 3GPP2 systems that are in the same geographic location as the UE. The UE may also be provisioned with an IS-683E Preferred Roaming List (PRL) that supports mapping between System Identifier/Network Identifier (SID/NID) and Mobile Country Code (MCC). The UE may also be provisioned with a 3GPP Band Support Table (BST) that gives a per-MCC listing of the 3GPP RATs the UE has credentials to access. Other tables include the Handset-based Pulse Code Dialing (HPCD) database used for plus-code dialing and which can also be used to learn the lapping between SID/NID and MCC. There may also be a Global Positioning System (GPS)-to-location table, which is a proprietary table that can be provisioned in the UE listing the country boundaries, with GPS latitudes and longitudes being specified as a polygon that circumscribes the country.

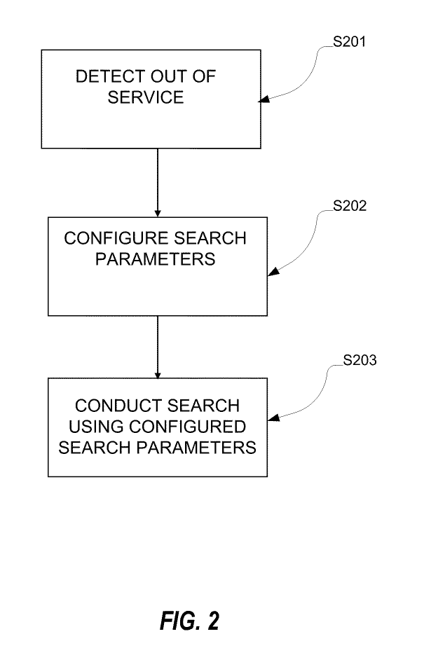

An exemplary process the UE can use to eliminate RATs is shown in FIG. 2. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In a step S201 shown in FIG. 2, an OOS condition is detected as described above. In response to the detection of the OOS condition, the wireless device 150 will conduct a search to discover a radio access technology so as to go back into service. The radio access technology the UE finds as a result of the search may be the same as that the UE was using when it went out of service, or it may be a different radio access technology. The UE generally will conduct its search as a series of scans.

The search conducted by the UE may be configured as shown in step S202 by configuring one or more search parameters. Once the search has been configured, then in step S203 the search is conducted using the configured search parameters.

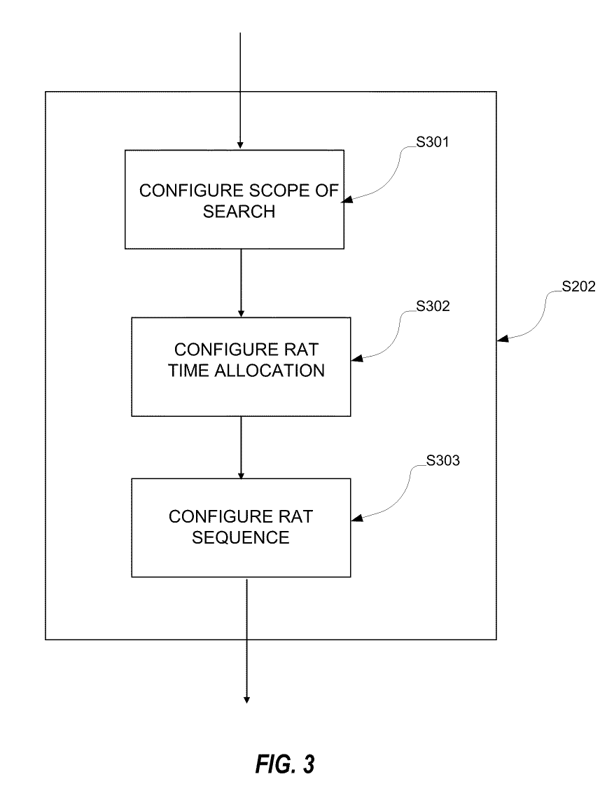

Turning now to FIG. 3, step S202 of configuring search parameters may include a step S301 of configuring the scope of the search (which RATs will be sought), at least during a certain set of scans such as an initial set of scans. The scope parameter may be conceptualized as a “scan list,” that is, the list of RATs that will be sought in a scan. It will be understood, however, that the scan list is merely intended to connote directly or indirectly which RATs of all possible RATs will be scanned, and is not necessarily intended to connote an actual list stored in memory, although the scan list could be such a list. For example, the scan list can be created by eliminating RATs from a first more comprehensive list of RATs with which the UE is provisioned so that the resulting scan list is a subset of the first list. The scan list can also be created by creating a list through filtering a list of RATs for which to scan, or by inversion by creating a list of RATS for which not to scan, and then scanning for all RATs not on the list. There could also be a master list of RATs, with the entry for each RAT including a flag that can be set to indicate whether that RAT should be scanned for or not. All of these scenarios are intended to be encompassed by the expression “scan list” and by the expression “eliminate” or “eliminating” radio access technologies from the scan list.

There may be several strategies useful for configuring the scope parameter. One such strategy is to use information relating to the RAT which the UE was using when it went OOS. This will be referred to here as the most recent RAT. In one aspect, the UE may use the specific type of technology employed by the most recent RAT to narrow the scope of the search. For example, the scope may be narrowed to looking only for RAT's employing the same technology as the most recent RAT. Similarly, UE may use the location (e.g., country) of the most recent RAT to narrow the scope of the search. The scope may be narrowed to looking only for RATs in the same location as the most recent RAT

A goal of configuring the search scope parameter is to determine whether it is possible to narrow the search by searching for fewer than all possible RATs and instead searching, at least at first, only for those RATs that are most likely to be within service range. This creates the possibility of more efficient scanning It will also be understood, however, that the result of scope configuration using a particular method may be that no RATs will be eliminated, that is, that it is not possible to narrow the search.

Another search parameter which may be configured is the allocation of time that the UE scans for each RAT on the scan list during each scan as shown in step S302. A goal of configuring the allocation parameter is to determine whether it is possible to search more efficiently, for example, by allocating more time to more likely RATs during each scan.

Another search parameter which may be configured is the sequence in which the UE scans for each RAT on the scan list during each scan as shown in step S303. A goal of configuring the sequence parameter is to determine whether it is possible to search more efficiently, for example, by searching for more likely RATs earlier in the search sequence.

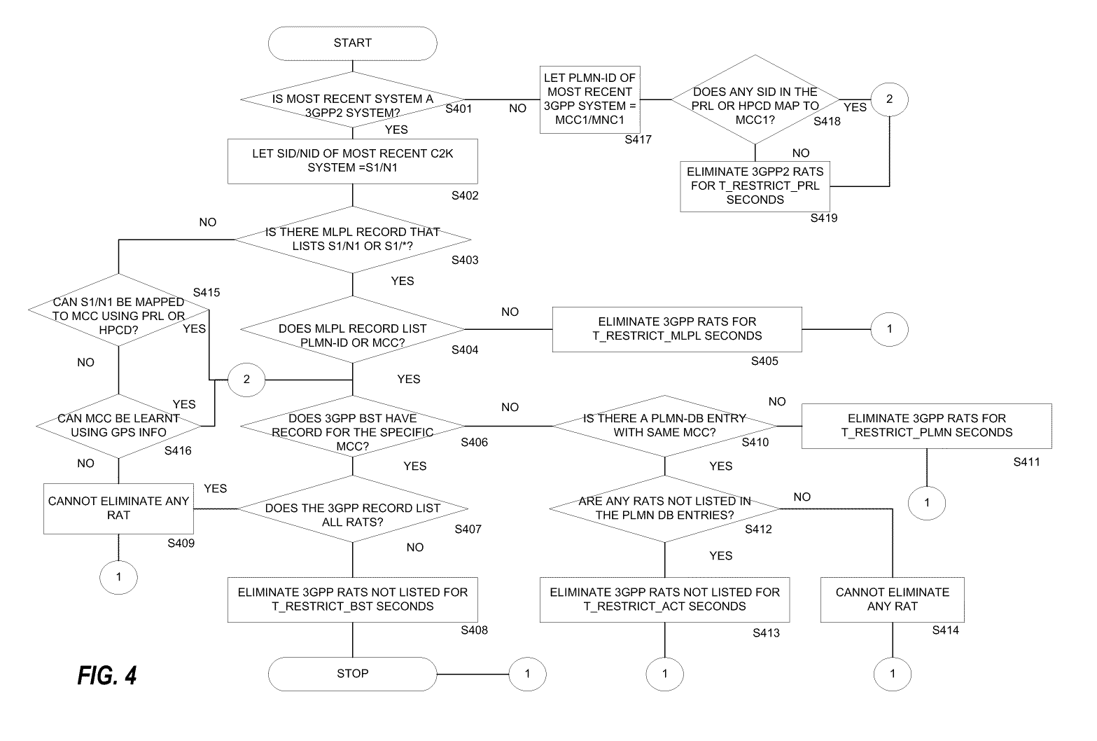

A specific example of configuration of the search scope parameter is now described in connection with FIG. 4. Assume that the UE was camped on a C2K system, i.e., a cdma2000 system with SID/NID S1/N1 when it went OOS. For the process shown in FIG. 4 the UE determines in step S401 that the most recently used system (“MRU”) (the C2K system that the UE was last in before it went OOS) was a 3GPP2 system. In step S402 the SID/NID of the most recent system is set equal to S1/N1. It is then determined in step S403 whether the UE's MLPL record lists S1/N1 or S1/* (where * is a wildcard operator intended to connote any N, e.g., N1, N2, etc.). Assuming the UE's MLPL record does list S1/N1 or S1*, the UE can determine what other systems are in the same location as S1/N1 by using the MLPL. For example, if in step S404 it is determined that the MLPL does not list any Public Land Mobile Network ID (PLMN-ID) or MCC, then no 3GPP systems are present in the same area as the C2K system. Thus, in step S405, all 3GPP RATs are eliminated from the scan list at least for a period of time, e.g. T_Restrict_MLPL seconds. In one aspect, which is not to be construed as limiting, a typical default value for T_Restrict_MLPL may be around 90 seconds.

If, on the other hand, the MLPL does list a PLMN-ID or MCC, and if it is determined in step S406 that the 3GPP BST contains a record for the MCC, and determined in step S407 that the 3GPP record does not list all RATs, any 3GPP RAT not listed in the 3GPP BST record for the MCC is eliminated from the scan list for a period of time, e.g. T_restrict_BST seconds, in step S8. In one aspect, which is not to be construed as limiting, a typical default value for T_restrict_BST seconds may be around 80 seconds.

If, on the other hand, it is determined in step S407 that the 3GPP record lists all RATs, then no RAT can be eliminated (step S409).

If, however, after the determination in step S406 it is determined in step S410 that the PLMN DB has no entries with the MCC, then in step S411 all 3GPP RATs may be eliminated for a time, e.g. T_Restrict_PLMN seconds. In one aspect, which is not to be construed as limiting, a typical value for T_Restrict_PLMN may be about 60 seconds.

If it is determined in step S410 that the PLMN DB does have entries with the MCC, it is then determined in step S412 whether there are any RATs not listed in the PLMN DB entries. If not, that is, for example, if it is determined that for a given RAT the PLMN DB entry has the access technology (AcT) bit for that RAT set equal to 0, thus indicating that the RAT is unavailable, that RAT is eliminated for a time period, e.g. T_Restrict_ACT seconds, in step S413. In one aspect, which is not to be construed as limiting, a typical value for T_Restrict_ACT may be about 120 seconds. If it is determined in step S412 that all RATs are listed in the PLMN DB entries, then no RAT can be eliminated (step S414).

If it is determined in step S403 that no MLPL exists, it is determined in step S415 whether S1/N1 can be mapped to a MCC using PRL. If not, it is determined in step S416 whether the MCC can be determined using GPS information. If the determination in either step S415 or S416 is affirmative, then the process flows to step S406 and subsequent steps. If, on the other hand, S1/N1 cannot be mapped to an MCC in step S415 or step S416, then no RAT can be eliminated (step S409).

As another example, assume the UE was camped on a 3GPP system when it went OOS. The determination in step S401 is then negative. In step S417 the PLMN-ID of the most recent system is taken as MCC1/MNC1. It is then determined in step S18 whether any entries in the PRL or HPCD map to MCC1. If not, it is assumed that MCC1 is a country without C2K coverage and in step S19 C2K RATs are eliminated from the scan list for a certain period of time, e.g. T_restrict_PRL seconds.

In an additional aspect, the length of time that certain RATs are eliminated from the scan list can be adjusted according to other parameters. For instance, it may be that the UE is permitted to camp on a system that is not listed in the PRL, i.e., the PREF-ONLY flag is set to 0. In that case, it may be desirable to eliminate that system for a shorter period of time, say, as a nonlimiting example, 90 seconds. On the other hand, T_restrict_PRL can be set to a longer value, which may be about 180 seconds, if PREF_ONLY=TRUE, indicating that the UE is not permitted to camp on systems that are not listed in the PRL.

If in step S418 it is determined that there is a PRL or HPCD entry that maps to MCC1, then the UE cannot eliminate the C2K RATs and the process flows to step S6 and subsequent steps. If it is determined in step S407 that the 3GPP BST has a record for MCC1 and does not list a certain 3GPP RAT, then that RAT is eliminated for T_Restrict_BST seconds.

Of course, the above is an example of a specific implementation of a system according to an aspect of the described apparatus and methods, used only to illustrate the general principles described herein. It will be apparent that the details of this example could be modified while still using the principles described herein.

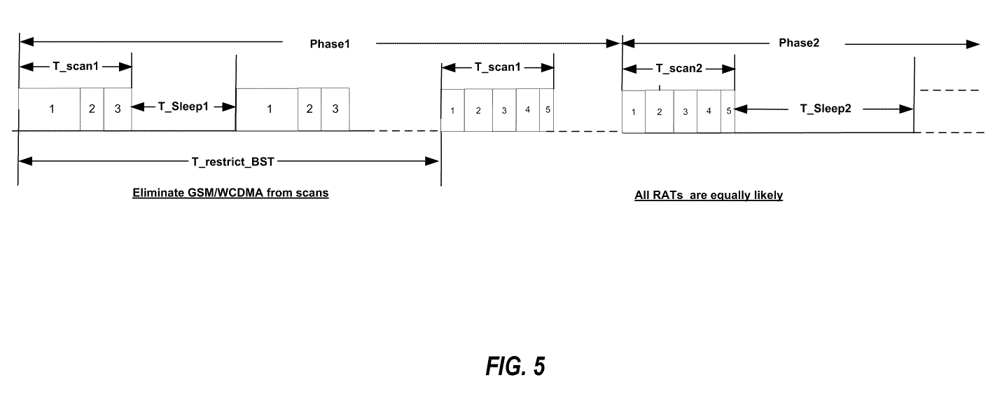

As a specific example of possible operation of a RAT elimination technique, FIG. 5. is a timing diagram for a possible scan timing according to one aspect. It is assumed for the case depicted in FIG. 5 that the UE can scan for four different RATs: (1) lx; (2) DO; (3) LTE/UMTS; and (4) GSM. It is also assumed that the UE belongs to a C2K operator in the United States (U.S.) and that the UE goes out-of-service in U.S.

In an aspect, because within the U.S. one 3GPP system of interest is LTE, the operator may list only the U.S. LTE band in the 3GPP BST. The RAT elimination logic may use this information to determine that no GSM/WCDMA systems of interest are available in the current MCC based on the procedures described in connection with FIG. 4. Hence, GSM/WCDMA scans are eliminated for T_restrict_BST seconds.

Thus, the UE can search more efficiently by using certain criteria to eliminate RATs from the scan order. Certain criteria have been described above, but other variations on these criteria and other criteria are possible. For example, the UE could first use the location of the most recently used RAT as a basis for refining the scan list by search only for RATs in the same location as the most recently used RAT. Alternatively, the search could be limited to RATs in the same location as the most recently used RAT and RATs in adjacent locations. Or, the search could initially be limited to RATs in the same location as the most recently used RAT but broadened to include RATs in adjacent locations if the original search yields no acceptable results after a time.

It is also possible that information acquired during a search could be used to modify the search parameters. For example, if the UE finds a service using a configured search, it may be desirable to keep looking for a better service. The UE could use information about the first-found service, however, to further refine its search. For example, the UE could use location information associated with the first-found RAT to reconfigure the search scope.

In another aspect, the UE can use information acquired from previous searches to configure a search. For example, the UE could store which RAT it located a previous time or previous times it went out of service when it was using or camped on a given RAT. This information could also be acquired at the network level over multiple UEs and provided to a given UE over the air as an update to a table stored in the UE. The UE could use this information to configure scan search. The UE can also use this information to configure scan allocation times or scan sequence.

The foregoing discussion has been primarily in terms of scanning or not scanning for radio access technologies. It is also possible, however, to scan or not scan for frequencies within a radio access technology in at least one scan. This could be advantageous, for example, when information provided to the UE indicates that those frequencies are less likely to be present. Also, it is possible to configure the search to cause causing certain frequencies within a radio access technology to be scanned more than once in a scan. This could be advantageous, for example, when information provided to the UE indicates that those frequencies are more likely to be present.

After the scan list has been determined by eliminating certain RATs, the OOS module conducts scans by cycling through the RATs remaining on the scan list in a round-robin fashion. In another aspect, the UE may also use rules to determine the amount of time that should be allocated to each RAT during a scan. For example, consider the case for determining the amount of time to be allocated to a particular 3GPP2 RAT during a scan. In an aspect, the UE uses the PRL to determine all the 3GPP2 systems that are present in the current location. After this, the UE calculates the number of channels associated with these systems. The UE also determines the priority of 3GPP2 in the current location using the Multi-Mode Selection System (MSS) System Priority List (MSPL) associated with the most recent system. The UE then uses these two parameters (the number of channels in the list, priority in the MSPL) with a lookup table to determine an amount of time to allocate to 3GPP2 RATs.

In an aspect, to determine the amount of time to be allocated to a 3GPP RAT, if the 3GPP BST contains a record for the “current,” e.g., most recent, MCC, then the UE can determine the number of bands allocated to the RAT in the MCC. If the 3GPP BST does not contain such a record, the UE takes a value for the number of bands equal to the number of bands supported by the UE for the particular 3GPP RAT. The UE then determines the priority of the 3GPP RAT in the current location from the MSPL. The UE then uses these two parameters (the number of channels in the list, priority in the MSPL) with a lookup table to determine an amount of time allocated to 3GPP RATs.

Of course the above description relates to just two examples of allocation techniques. Other allocation techniques are possible. It should also be noted that the scan list may be created by setting the allocation time for a particular RAT equal to zero. This is one example of the steps of configuring the search scope and the allocation step being accomplished together. Thus, these steps need not be discrete, and do not need to be carried out in any particular order.

In another aspect, the UE also uses rules to determine a sequence or scan order in which the UE scans for RATs. Typically, the UE maintains a list of most recently used systems (MRU). In a conventional system, the UE stores only band/channel and RAT level information for each MRU. In order to improve scanning by improving scan order, it is advantageous to store additional information for each MRU, such as system level information. Such system level information could include one or more of SID/NID, SubnetID, PLMN-ID, etc. It may be also advantageous to store location information for each MRU. Such location information could include MCC, associated MSPL, etc.

As an example of one technique for determining scan order, the first RAT in the sequence may be based on the first entry in the MRU list (MRU[0]). For instance, if the MRU[0] system is a 1x system, the UE assigns 1x the first time-slot in the scan order. The UE will then determine which RAT to assign to the second slot in the scan order by selecting the next MRU entry that is in the same location as MRU[0].

As a specific example, suppose MRU[0] is a 1x system in MCC1, MRU[1] is a 1x system in MCC1, MRU[2] is a GSM system in MCC2 and MRU[3] is a LTE system in MCC1. Using the technique described above, the UE will assign the first scan slot to 1x because the first entry in the MRU is a 1x system. Having already allocated a scan slot to 1x, the UE will then assign the second scan slot to the MRU also having MCC1, that is, LTE.

If none of the other MRUs is in the same location, the UE can chose the next RAT based on priority in the MSPL associated with MRU[0].

Thus, in an aspect, the UE then scans using the scan list, scanning the RATs that are still in contention, each for the allocated scan time, and in the determined scan order. The UE will continue this scanning until it finds a RAT that can provide service. As noted, after certain intervals have passed, a RAT that was previously eliminated from the scan list may be reinstated to the scan list if searching with the reduced list does not find any available radio access technology after certain intervals.

Again, while in the above description the step of configuring scan sequence is described separately from and after the other configuration steps, it is not necessary that scan sequence be configured after or separately from the other configuration steps.

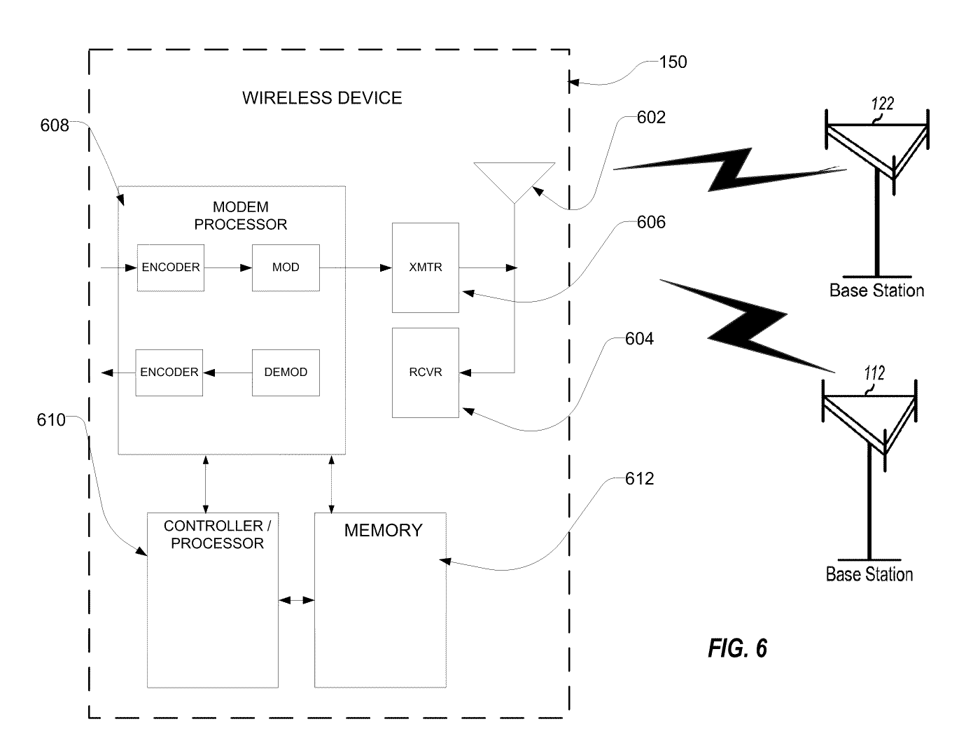

Referring now to FIG. 6, a block diagram illustrating an example of a wireless communication system in which various aspects described herein can function is provided. Base stations 112 and 122 as shown in FIG. 1 are within range and capable of servicing wireless device 150. Wireless device 150 includes an antenna 602 for receiving signals from base stations 112 and 122. Antenna 602 is coupled to a receiver 604 and a transmitter 606. Receiver 604 and a transmitter 606 are coupled to a modem processor 608 which demodulates signals received by the antenna 602 and modulates signals to be sent by the antenna 602. The modem processor 608 is in turn coupled to a controller/processor 610 and a memory 612. The controller/processor 610 is coupled to the memory 612. The memory 612 holds various instructions which the controller/processor 610 executes to perform the various functions and operations described above. The controller/processor 610 operating executing these instructions comprises various means for performing the functions and operations described above. The memory 612 also holds the various databases and lists described above, such as MCC, PRL, HPCD, BST, and MRU.

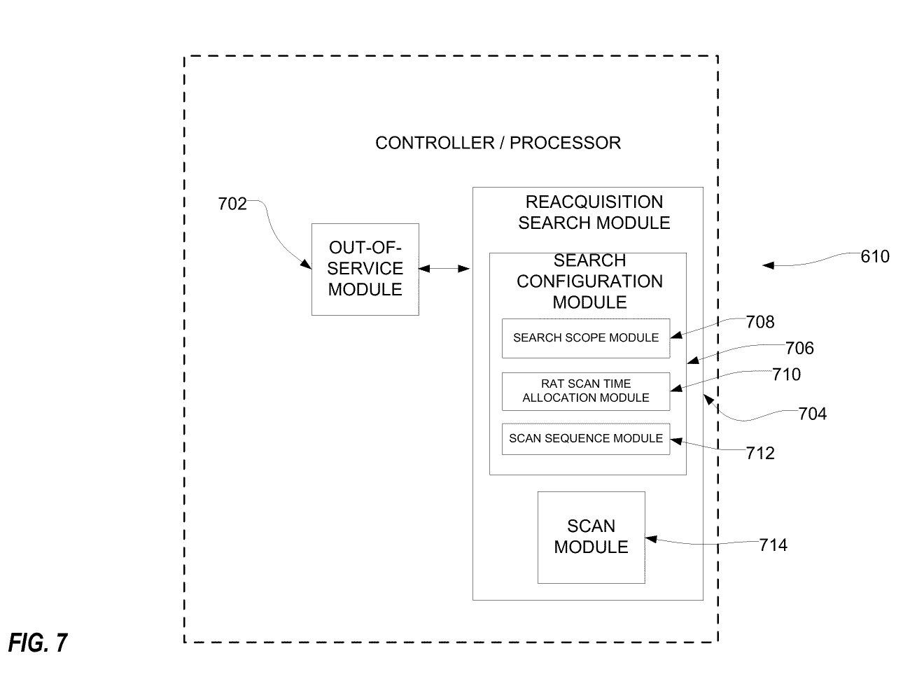

Referring now to FIG. 7, a block diagram illustrating an example of a controller / processor 610 is shown. As depicted, the controller/processor 610 includes an out-of-service module 702 that detects an out-of-service condition and provides an indication of the detection to a reacquisition search module 704. The reacquisition search module 704 causes the UE to conduct a search for a radio access technology. The search parameters are configured by a search configuration module 706. The search configurations module 706 defines the search in accordance with one, all, or any combination of modules as shown. These modules may include a search scope module 708 that determines which RATs will be searched for, a RAT scan time allocation module 710 that determines how much of a scan to allocate to a given RAT, and a scan sequence module 712 that determines the order in which to scan for RATs. Once the search configuration module 706 configures the search, a scan module 714 causes the search to be conducted in accordance with the search parameters configured by the search configuration module 706. These modules may be implemented as the controller/processor 410 executing instructions stored in memory 412.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

What is claimed is:

1. Apparatus for wireless communications comprising:
at least one processor configured to cause said apparatus to transition to an out-of-service (OOS) state upon detection of an OOS condition for a first radio access technology,
configure at least one parameter of a system search to reacquire a second radio access technology the same as or different from said first radio access technology based on at least one attribute of said first radio access technology, and
cause said apparatus to conduct said system search; and
a memory coupled to the at least one processor.

2. The apparatus of claim 1, wherein said at least one processor is further configured to determine which radio access technologies are most likely to be found based in least in part on said first attribute.

3. The apparatus of claim 1, wherein said at least one attribute of said first radio access technology is a type of air interface technology employed by said first radio access technology.

4. The apparatus of claim 1, wherein said at least one attribute of said first radio access technology is a location associated with said first radio access technology.

5. The apparatus of claim 1, wherein said at least one parameter is a scan list of systems to be sought during said system search.

6. The apparatus of claim 5, wherein said processor is further configured to determine said scan list by causing certain frequencies within a radio access technology to be eliminated in at least one scan.

7. The apparatus of claim 5, wherein said processor is further configured to determine said scan list by causing certain frequencies within a radio access technology to be repeated multiple times in at least one scan.

8. The apparatus of claim 5 wherein said processor is further configured to
determine said scan list by causing selected radio access technologies not to be scanned for in at least one scan.

9. The apparatus of claim 8 wherein said processor is configured to cause said selected radio access technologies not to be scanned by eliminating said selected radio access technologies from said scan list.

10. The apparatus of claim 1, wherein said at least one parameter is an amount of time a radio access technology is sought in at least one scan of said system search.

11. The apparatus of claim 1, wherein said at least one parameter is an order in which radio access technologies are sought during said system search.

12. The apparatus of claim 1 wherein said at least one processor is configured to be able to configure at least parameter of said system search based on by causing selected radio access technologies not to appear on a scan list of radio access technologies to be sought for at least one scan, by determining an amount of time during said at least one scan to seek radio access technologies on said scan list, and by determining an order in which to search for radio access technologies on said scan list.

13. A method comprising:
transitioning to an out-of-service (OOS) state upon detection of an OOS condition for a first radio access technology; and
defining a system search based on at least one parameter to reacquire a second radio access technology the same as or different from said first radio access technology, wherein the at least one parameter is based on at least one attribute of said first radio access technology and
performing said system search.

14. The method of claim 13, wherein said at least one attribute of said first radio access technology is a type of air access technology employed by said first radio access technology.

15. The method of claim 13, wherein said at least one attribute of said first radio access technology is a location associated with said first radio access technology.

16. The method of claim 13, wherein said at least one parameter is a scan list of systems to be sought during at least a portion of said system search.

17. The method of claim 16 wherein said scan list is defined by causing selected radio access technologies not to appear on said scan list.

18. The method of claim 13, wherein said at least one parameter is an amount of time a radio access technology is sought in at least one scan of said system search.

19. The method of claim 13, wherein said at least one parameter is an order in which radio access technologies are sought in at least one scan of said system search.

20. The method of claim 13, wherein said defining step comprises
causing selected radio access technologies not to be sought during at least a portion of said system search,
allocating an amount of time to scan for radio access technologies at least one scan of said system search, and
determining a sequence in which to search for radio access technologies in at least one scan of said system search.

21. Apparatus comprising:
means for transitioning to an out-of-service (OOS) state upon detection of an OOS condition for a first radio access technology; and
means for performing a system search based on at least one parameter to reacquire a second radio access technology the same as or different from said first radio access technology, wherein the at least one parameter is based on at least one attribute of said first radio access technology.

22. The apparatus of claim 21, wherein said at least one attribute of said first radio access technology is a type of air access technology employed by said first radio access technology.

23. The apparatus of claim 21, wherein said at least one attribute of said first radio access technology is a location associated with said first radio access technology.

24. The apparatus of claim 21, wherein said at least one parameter is a scan list of radio access technologies to be sought during said system search.

25. The apparatus of claim 21 wherein said search defining means comprises means for selecting radio access technologies not to be sought during at least one scan of said system search.

26. The apparatus of claim 21, wherein said search defining means comprises scan time allocating means for allocating an amount of time a radio access technology is scanned for in during at least one scan of said system search.

27. The apparatus of claim 21, wherein said search defining means comprises sequence determining means for determining an order in which radio access technologies are sought during at least one scan of said system search.

28. The apparatus of claim 21 wherein said determining means comprises:
means for causing selected radio access technologies not to be searched for during at least one scan of said system search;
means for allocating an amount of time to scan for radio access technologies in at least one scan of said system search; and
means for determining a sequence in which to search for radio access technologies in at least one scan of said system search.

29. A computer program product, comprising:
a computer-readable medium comprising
a first set of codes for causing a computer to transition to an out-of-service (OOS) state upon detection of OOS conditions for a first radio access technology; and
a second set of codes for causing a computer to determine at least one parameter of system search to reacquire a second radio access technology the same as or different from said first radio access technology based at least in part on at least one attribute of said first radio access technology.

30. Apparatus comprising:
an out-of-service module configured to detect an out-of-service condition for a first radio access technology;
a reacquisition search module coupled to said out-of-service module and configured to perform a system search to reacquire a second radio access technology the same as or different from said first radio access technology in response to detection of an out-of-service condition by said out-of service module, said reacquisition search module including a search defining module configured to determine at least one parameter of said system search based on at least one attribute of said first radio access technology.

31. Apparatus for wireless communications comprising:
at least one processor configured to
cause said apparatus to transition to an out-of-service (OOS) state upon detection of an OOS condition for a first radio access technology,
configure at least one parameter of a system search to reacquire a second radio access technology the same as or different from said first radio access technology based on an apparent location of said apparatus, and
cause said apparatus to conduct said system search; and
a memory coupled to the at least one processor.

32. The apparatus of claim 31 wherein said at least one processor is additionally configured to determine said apparent location of said apparatus from location information associated with said first radio access technology.

33. The apparatus of claim 31 wherein said at least one processor is additionally configured to
determine said apparent location of said apparatus from location information associated with said first radio access technology and
configure said at least one parameter of a system search to reacquire said second radio access technology based on said apparent location of said apparatus by limiting at least an initial scope of said search to radio access technologies in said apparent location.
